(19) United States
(12) Patent Application Publication
(10) Pub. No.: US 2017/0091390 A1
(43) Pub. Date: Mar. 30, 2017

(54) DELIVERING CUSTOMER INFORMATION FROM CUSTOMER CARE SITE TO CUSTOMER CARE AGENT

(71) Applicant: T-Mobile USA, Inc., Bellevue, WA (US)

(72) Inventor: Christopher Harvey Joul, Bellevue, WA (US)

(21) Appl. No.: 14/871,343

(22) Filed: Sep. 30, 2015

(51) Int. Cl. G06F 19/00; G06Q 50/22; G06Q 30/00

(52) U.S. Cl. CPC G06F 19/322; G06Q 30/016; G06Q 50/22

(57) ABSTRACT

A customer care site includes a plurality of pages that may individually include a call link to communicate with customer agents. When a customer tries to contact a customer agent via a call link in one of the plurality of pages on the customer care web site, a computing system associated with the customer care site transmits customer information regarding the customer's specific activities prior to selecting the call link on the customer care web site. When a customer agent responds to the customer's call, a computing device of the customer agent can display the customer information transmitted from the computing system associated with the customer care web site. As the customer agent knows about the customer's prior activities on the customer care site through access to the detailed customer information provided by the computing system, the customer agent does not need to repeat the same procedure or inquiries that the customer has already traversed on the customer care web site.

### BACKGROUND

A web site is one of the most important channels for a business to attract potential customers, sell products or services, and communicate with customers. For the customer care operation, a variety of information including billing information, promotion information, and technical support can be provided for customers via a customer care web site. The customers navigate the customer care site to find useful information and may spend some time answering questions to guide the customers on the customer care web site. However, even after spending much time exploring the customer care web site, customers may not find the information they are looking for. Then, the customers may try to contact a customer care agent or representative to address their issues. However, customer care agents or representatives who respond to calls from the customers may repeat the same questions that the customers already have answered because they have no idea about the customers' previous activities on the customer care web site, which creates a poor customer experience.

### BRIEF DESCRIPTION OF DRAWINGS

The foregoing aspects and many of the attendant advantages of this disclosure will become more readily appreciated by reference to the following detailed description, when taken in conjunction with the accompanying drawings, wherein:

FIG. 1 is a block diagram depicting an illustrative environment for delivering customer information from a customer care site to customer care agents.

FIG. 2 is a block diagram depicting an illustrative environment including an intermediary system that is configured to manage communication between different networks.

FIG. 3 is a block diagram illustrating processes associated with the delivery of customer information from a customer care site to customer care agents.

FIG. 4 illustrates an example of a customer care page including a call link.

FIG. 5 illustrates an example of a customer care agent page displaying customer information via a customer care agent device.

### DETAILED DESCRIPTION

Some embodiments of the present disclosure are directed to delivering customer information associated with a customer care site to a customer request management system associated with agents who may respond to a customer's call.

In a networked environment, a customer care site provides a variety of information regarding promotion, billing, available offerings, and technical support for current or potential customers. The customer care site may be a web site including a plurality of web pages. Some of the web pages on the customer care site include a link to initiate a request for further assistance. When a user of the customer care site the link, a request for further assistance is transmitted from a user device to a computing system associated with the customer care site. In response to a request from the user device, the computing system associated with the customer care site identifies destination information corresponding to the link. The destination information represents a party to whom the request (or a notice of the request) is directed. The destination information can identify a specific customer care agent who has a specialty in issues represented by a web page which includes the link. Using the destination information, the computing system can initiate for establishing a communication session (voice and/or video call) between the user and a customer care agent. The computing system can establish a communication session between the user device and a device of the customer care agent. The computing system can retrieve customer activity information or historical customer care information of the user, from a data store connected to the computing system. The computing system provides the retrieved information to the customer care agent whom the request is directed. The customer activity information includes information about interactions of customers at the customer care site prior to making the request via the link. The historical customer care information includes, for example, one or more prior interactions of the customer with the one or more customer care agent devices or previous issues about which the customer has previously requested consultation. The computing system provides the customer activity information (or historical customer care information), directly or indirectly, to a computing device associated with the customer care agent using the destination information.

In some embodiments, the destination information corresponding to the link on the customer care site identifies a specific customer care agent (or group of customer care agents) who has a specialty in subjects and/or issues represented by the page containing the link. The destination information can identify a one or more customer care agents (or their devices). Based on information about the customer, such as a type of the customer's account, product/service purchased by the customer, product/service the customer showed interest in, and available offerings for the customer, requests of customers can be directed different customer care agents. In some embodiments, when the destination information does not identify a specific customer care agent, the customer's request may be forwarded to any available customer care agent.

Specific embodiments and example applications of the present disclosure will now be described with reference to the drawings. These embodiments and example applications are intended to illustrate, and not limit, the present disclosure.

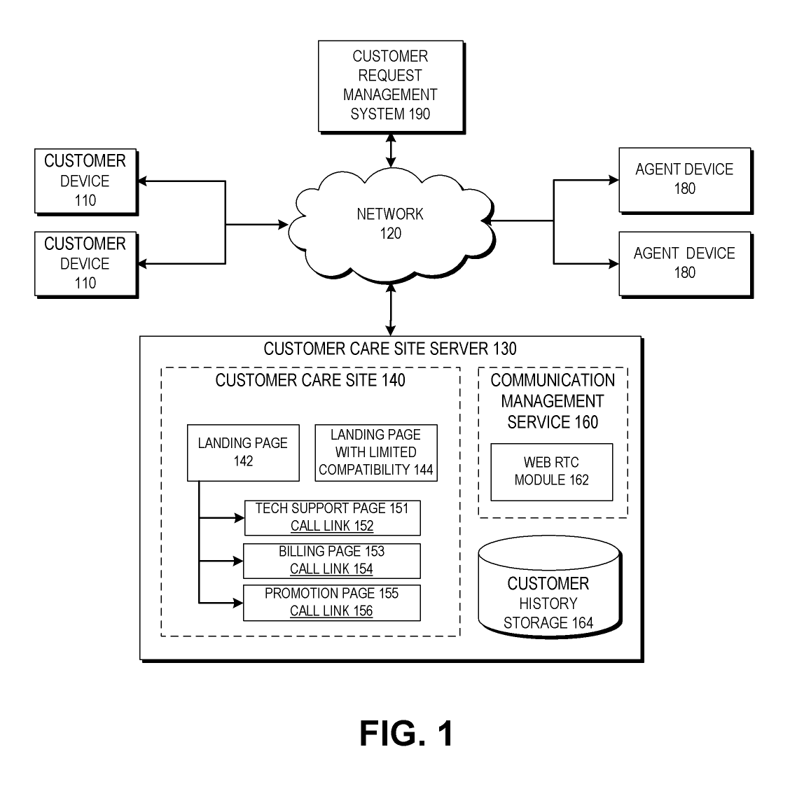

FIG. 1 is a block diagram depicting an illustrative environment for delivering customer information from a customer care site to customer care agents. The environment shown in FIG. 1 includes a customer device 110, a network 120, a customer care site server 130, an agent device 180, and a customer request management system 190.

The customer device 110 could be one of a wide variety of computing devices, including personal computing devices, terminal computing devices, laptop computing devices, tablet computing devices, electronic reader devices, mobile devices (e.g., mobile phones, media players, handheld gaming devices, etc.), wearable devices with network access and program execution capabilities (e.g., “smart watches” or “smart eyewear”), wireless devices, set-top boxes, gaming consoles, entertainment systems, televisions with network access and program execution capabilities (e.g., “smart TVs”), and various other electronic devices and appliances. The customer device 110 may execute a browser application to communicate via the network 120 with other computing systems, such as the customer care site server 130 and the agent device 180.

The network 120 may be a publicly accessible network of linked networks, possibly operated by various distinct parties, such as the Internet. In other embodiments, the network 120 may include a private network, personal area network, local area network, wide area network, cable network, satellite network, cellular telephone network, etc., or combination thereof, each with access to and/or from the Internet. The customer device 110 communicates with the customer care site server 130 via the network 120. The customer care site server 130 can facilitate and/or establish a voice/video call between the customer device 110 and the agent device 180, such as in response to a request from the customer device 110, via a customer care site 140. The customer care site server 130 can communicate with the customer request management system 190 to deliver customer information in response to a request to establish a communication session between the customer device 110 and the agent device 180. The customer request management system 190 can provide customer information received from the customer care site server 130 to the agent device 180.

The customer care site server 130 is operable to provide a customer care site 140 that is accessible to the customer device 110. The customer care site 140 is a web site containing information for existing customers, potential customers, or other users of the web site. The customer care site 140 provides a plurality of web pages including one or more landing pages and subpages of the landing pages. The customer care site 140 may provide different landing pages for different types of customer devices and/or browsing software of the customer devices. The customer care site server 130 can identify a type of the customer device and/or browsing software of the customer device using a script or code embedded in a page of customer care site 140. Based on the identified type of the customer device and/or the browsing software, the customer care site 130 provides a corresponding landing page. In some embodiments, when the customer care site server 130 requires a specific feature (for example, a web RTC feature) to implement some embodiments of the present invention, a browser that does not support the specific feature may be directed to a landing page with limited compatibility 144 rather than a landing page 142 that is configured to utilize the specific feature. The landing page with limited compatibility 144 includes an informative message that additional features may be available for different devices or browsers.

Customers visiting the customer care site 140 can navigate from the landing page 142 to different sub-pages, such as a technical support page 151, a billing page 153, and a promotion page 155, based on their needs. Web pages on the customer care site 140 may request that the customers answer questions to explore the customer care site 140. For example, the landing page 142 may include questions for the customers about issues that the customers need addressed. Web pages on the customer care site 140 may also include questions to obtain a better understanding of customers' issues. For example, the technical support page 151 may include questions about technical difficulties of customers and about basic troubleshooting actions already taken by the customers.

In some embodiments, the web pages on the customer care site 140 may further include a link for requesting communication with a customer care agent. The technical support page 151, the billing page 153, and the promotion page 155 include call links 152, 154, 156, respectively. Each of the call links 152, 154, 156 corresponds to destination information (number) specifying a responding party of the request. The destination information of the call links 152, 154, 156 can be assigned statically based on identification, type, category, and/or subject of the web pages that include the call links. For example, the destination information of the call link 153 may be a telephone number or IP address that is associated with a technician department, and the destination information of the call link 154 may be a telephone number or IP address associated with an accounting department. In some embodiments, the destination information of the call links 152, 154, 156 can vary dynamically based on a customer's action on the customer care site 140. For example, if a customer noted that he/she resides in a specific state, the customer care site 140 can assign a number of a promotion agency associated with the specific state as the destination information of the call link 156. As such, the destination information of the call links can be determined dynamically based on answers to questions presented on the customer care site 140. When a customer clicks or selects one of the call links, the customer device 110, and/or the customer care site server 130 transmits a request for establishing a communication session to a communication management service 160. In some embodiments, the destination information is included in a resource identifier (for example, URL) associated with the call links.

The communication management service 160 is a computing component, which can comprise computer hardware and/or software, of the customer care site server 130 and is operable to manage communication between the customer device 110 and the agent device 180 in response to a request for establishing a communication session. The communication management service 160 includes a web RTC module 162 that is operable to establish, facilitate, and manage a communication session (voice/video/live chat) between the customer device 110 and the agent device 180 in cooperation with corresponding web RTC components in the customer device 110 and the agent device 180. A web browser that supports a web RTC feature can cooperate with the web RTC module 162 to establish a communication session with the agent device 180 for real-time communication including voice/video call. Using information contained in a request made via one of the call links 152, 154, 156, the communication management service 160 identifies destination information of a call link associated with the request. To identify the destination information, the communication management service 160 can utilize customer information associated with the customer who made the request via the call links. Using the identified destination information, communication management service 160 establishes a communication session between the customer device 110 and the agent device 180 corresponding to the identified destination information. In addition, using information contained in the request, the communication management service 160 recognizes identification of the customer device 110 or its user. Using the recognized identification, the communication management service 160 can retrieve, from the customer history storage 164, customer information customer information that will be provided to a customer care agent who responds to the request from information stored within the customer care site server 130. The customer information can include customer activity information and historical customer care information. The communication management service 160 can provide the retrieved customer information to the agent device 180 that corresponds to the identified destination information. The communication management service 160 can generate a web page containing the retrieved customer information and transmit the generated web page to the agent device 180.

In some embodiments, the communication management service 160 is operable to deliver customer information from the customer care site server 130 to the request management system 190. The customer information that will be delivered from the customer care site server 130 to the customer request management system 190 may include a variety of information that would be useful for a customer care agent to help the customer who is talking with the customer care agent. The customer information can include account information, identification of a page from which the customer requested communication with a customer care agent, issues the customer tried to address on the customer care site 140, and actions taken by the customer on the customer care site 140 prior to requesting communication with a customer care agent. The communication management service 160 can cause the request management system 190 to forward the customer information to the agent device 180. In some embodiment, the communication management service 160 can forward requests made via the call links to the request management system 190 such that the request management system 190 can identify customer information based on the forwarded request.

In some embodiments, in response to a request made via a call link, the communication management service 160 can request the customer request management system 190 to deliver customer information to the agent device 180. For facilitating delivery of customer information by the customer request management system 190, the communication management service 160 can utilize an identification assigned to the request or communication session established based on the request. Before the communication management service 160 initiates a communication session between the customer device 110 and the agent device 180 or after the communication session has been established, the communication management service 160 can assign an identification to the request or the established communication session. The communication management service 160 also associate the assigned identification with identification of the customer device 110, identification of the agent device 180, and any other information that can identify a calling party (user of the customer device 110) and a responding party (agent using the agent device 180). The communication management service 160 transmits the assigned identification to the customer request management system 190 such that the customer request management system 190 can provide customer information along with the assigned identification to the agent device 180. In some embodiments, the communication management service 160 can also transmit, to the request management system 190, destination information of a call link associated with a request made via the link. Using the information received from the communication management service 160, the customer request management system 190 can identify to the agent device 180 participating in a communication session associated with the identification and provide the customer information to the identified agent device.

As shown in FIG. 1, the communication management service 160 is included in the customer care site server 130. However, in certain embodiments, the communication management service 160 can be implemented by another, separate computing system apart from the customer care site server 130. In some embodiments, the communication management service 160 can transmit the customer information directly to the agent device 180 when a direct communication channel can be established between the communication management service 160 and the agent device 180.

The customer care site server 130 shown in FIG. 1 may also include a local storage component, such as the customer history storage 164. The customer history storage 164 may comprise a database that is configured to store and manage customer information associated with the customer care site 140 and/or the communication management service 160. For example, the customer history storage 164 can manage various information of a customer in association with identification of the customer. The customer history storage 164 can manage account information, preference information, customer activity information, historical customer care information. The customer activity information can include interactions at the customer care site 140, answers to questionnaires on the customer care site 140, identification of web pages of the customer care site that customers visited, interaction with one or more web pages of the customer care site, a hierarchy of web pages of the customer care site traversed prior to making a request via the call links. The historical customer care information includes interactions with customer care agents (or customer care agent devices) prior to making a request via the call links. The communication management service 160 and the customer request management system 190 can retrieve the information stored in the customer history storage 164 using identification of the customer or identification of a device that the customer uses.

The agent device 180 is a device that a customer care agent uses for communication with the customer. The agent device 180 could be one of various computing devices including, but not limited to, personal computing devices, terminal computing devices, laptop computing devices and tablet computing devices.

The customer request management system 190 is a computer system that is configured to store and manage a variety of information related to customer care operations. For example, the customer request management system 190 stores identification information of customers including potential customers, product, and/or services provided for the customers, products, and/or services available for the customers, and customer care history associated with the customers. The customer request management system 190 is accessible by the agent devices 180. The customer care agents (representatives) can access, via the agent devices 180, the information stored in the customer request management system 190 and make changes to the information. In certain embodiments, when customer care site server 130 initiates, in response to a request from the customer device 110, a communication session between the customer device 110 and the agent device 180, the customer request management system 190 will receive, from the customer care site server 130, information about the calling party (customer information) that is stored in the customer history storage 164. The received information may be associated with an identification assigned to the requested and/or established communication session between the customer device 110 and the agent device 180. The customer request management system 190 may receive a request for related information from the agent device 180 that is in communication with the customer device 110. By utilizing the assigned identification, the customer request management system 190 can in turn identify related customer information and provide the related customer information to the agent device 180.

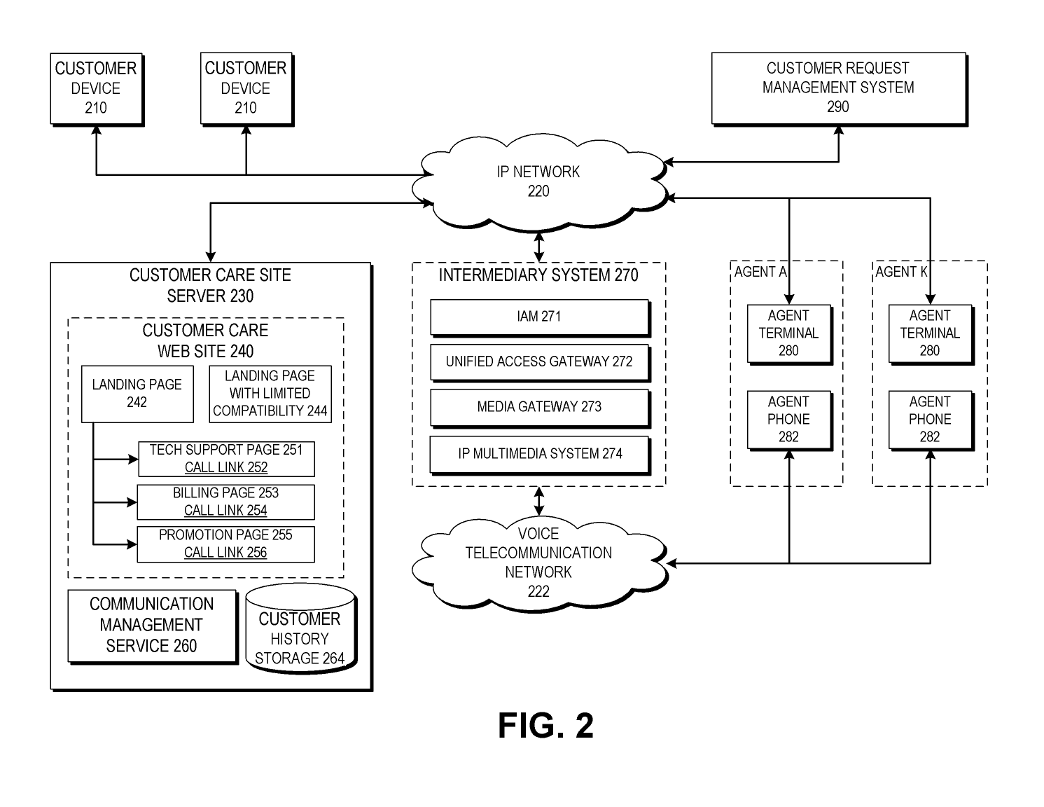

FIG. 2 is a block diagram depicting an illustrative environment of an intermediary system that is configured to manage communication between a customer device on an IP network and an agent phone on a voice telecommunication network. The environment shown in FIG. 2 includes a customer device 210, an IP network 220, a voice telecommunication network 222, a customer care site server 230 providing a customer care site 240, an intermediary system 270, an agent terminal 280, an agent phone 282, and a customer request management system 290.

The customer device 210 can be one of a wide variety of computing devices that is operable to communicate with the customer care site server 230 and the agent phone 282 connected to the voice telecommunication network 222. Configuration and features of the customer device 210 can be understood in reference to the description of the customer device 110 provided above in connection with FIG. 1. Customers navigate the customer care site 240 using the customer device 210. When needed, the customers can request communication with customer care agents or representatives by clicking or selecting call links 252, 254, 256 on customer care web pages 251, 253, 255.

The customer care site server 230 provides the customer care site 240. The customer care site server 230 can obtain hardware/software information relating to the customer device using a script or code embedded in a page of the customer care site 240. Based on the obtained hardware/software information associated with the customer device 210, the customer care site 240 provides a corresponding landing page from landing pages 242, 244. The customer care site server 230 includes a communication management service 260 that handles requests to contact customer agents. The customer care site server 230 also includes a customer history storage 264 configured to store and manage a variety of information associated with customers who visit the customer care web sites 240. The configuration and features of the components in the customer care site server 230 can be further understood in reference with the description of the customer care site server 130 presented above in connection with FIG. 1.

The communication management service 260 is operable to initiate, establish, and manage a communication session between the customer device 210 and the agent phone 282 (and/or the agent terminal 280). If a customer requested a video call and the agent phone 282 does not support a video call feature, the communication management service 260 can initiate a video call between the customer device 210 and the agent terminal 280 rather than the agent phone 282. The communication management service 260 is also operable to provide customer information, associated with the customer who requested communication with customer care agent or representative, to the agent terminal 280 via the customer request management system 290. In some embodiments, the communication management service 260 can establish a voice call between the customer device 210 and the agent phone 282, while it transmits customer information to the agent terminal 280 directly or indirectly via the customer request management system 290.

As such, while the communication management service 260 manages a communication session between the customer device 210 and a customer care agent's device, the communication management service 260 can also provide customer information to the customer agent's device. The customer request management system 290 can maintain a list of devices assigned to customer care agents. When a customer care agent communicates with a customer via a first device, the customer request management system 290 can identify a second device assigned to the same customer care agent and cause the identified second device to display customer information associated with the same customer.

With continued reference to FIG. 2, the intermediary system 270 includes Identity and Access Management (IAM) system 271, Unified Access Gateway (UAG) 272, Media Gateway (MGW) 273, and IP Multimedia System (IMS) 274. The intermediary system 270 is operable to facilitate communication and information exchange across two different networks, the IP network 220, and the voice telecommunication network 222. For example, when the customer device 210 is a tablet computer connected to the Internet and the agent phone 282 is a telephone connected to a PSTN (public switched telephone network), the intermediary system 270 can facilitate communication between the customer's tablet connected to the Internet and the agent's telephone connected to the PSTN.

Identity and Access Management system 271 is a computing system that facilitates the management of the identity information of customers. Identity and Access Management system 271 can be used to initiate, capture, record, and manage customer identities and their related access permissions in an automated fashion. The Unified Access Gateway 272 is a computing system that can connect a web RTC module, such as web RTC module 162 as depicted in FIG. 1 and which can be included in the communication management service 160 or 260, to the IP Multimedia System 274. The media gateway 273 is a device and/or service that converts digital media streams between disparate telecommunications networks. The IP Multimedia System 274 may generally enable multimedia communications across networks over multiple transport protocols.

The intermediary system 270 may be a single computing device, or it may include multiple distinct computing devices, such as computer servers, logically or physically grouped together to collectively operate as an intermediary system. The components of the intermediary system 270 can each be implemented as hardware, such as a server computing device, or as a combination of hardware and software. In addition, the modules and components of the intermediary system 270 can be combined on one server computing device or separated individually or into groups on several server computing devices. In some embodiments, the intermediary system 270 may include additional or fewer components than illustrated in FIG. 2.

The customer care agents (agent A and agent K) who respond to calls from the customers may use the agent terminal 280 and/or the agent phone 282. In some embodiments, the agent phone 282 is a traditional landline phone connected to the telecommunication network 222 and thus offers limited options for receiving detailed information about the caller, such as detailed information about traversal of the customer care web site. In addition or alternatively, the customer agents may use the agent terminal 280, which is connected to the customer request management system 280 via the IP network 220, for obtaining more detailed information that may not be available via the agent phone 282. In some embodiments, when the agent terminal 280 includes a voice call module that can handle voice communication on the IP network 220 or the voice telecommunication network 222, a customer care agent can communicate with the customer without using the agent phone 282.

The customer request management system 290 is a computing system that is configured to store and manage a variety of information related to customer care operations. Configurations and functions of the customer request management system 290 can be understood in reference with configurations and functions of the customer request management system 190 described above. The customer request management system 290 is connected to the IP network 220 and communicates with the customer care site server 230 to obtain customer information of a customer who has requested a call with a customer care agent. The customer request management system 290 provides the customer information to the agent terminal 280 which is assigned to the customer care agent who is responding to the requested call. To identify a corresponding agent terminal, the customer request management system 290 can utilize request identification or other identification associated with the calling party (customer).

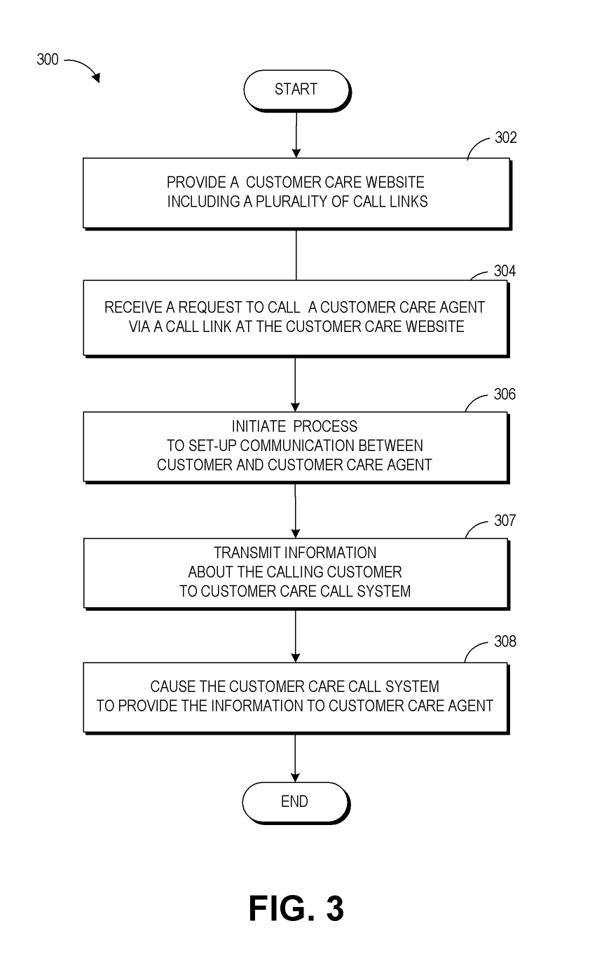

FIG. 3 is a block diagram illustrating processes associated with delivery of customer information from a customer care site to customer care agents. Processes illustrated in FIG. 3 can be implemented by a customer care site server 130, 230.

At block 302, the customer care site server 130, 230 provides the customer care site 140, 240 to the customer device 110, 210. Some of the web pages on the customer care site include call links for requesting communication with customer care agents or representatives. As described above, the destination information associated with the call links can be assigned statically based on information associated with the web pages that include the call links or can be assigned dynamically based on actions/activities of the customer at the customer care site 140, 240.

At block 304, the customer care site server 130, 230 receives a request to contact a customer care agent when a customer clicks or selects one of the call links provided on the customer care site 140, 240. The request to contact a customer care agent can be handled by the communication management service 160, 260 of the customer care site server 130, 230.

At block 306, the communication management service 160, 260 initiates a process to set up a communication session between the customer device 110, 210 and the one or more devices 180, 280, 282 of customer care agents. In embodiments where the customer device 110, 210 supports a web RTC feature, the web RTC module 162 of the communication management service 160, 260 can establish and manage a communication session (voice/video call) in cooperation with a corresponding web RTC component in the customer device 110, 210. The communication management service 160, 260 generates and assigns identification information to the request and/or established communication session to manage customer information of the calling party (customer) in association with the request and/or established communication session. The assigned identification information can be stored in a data storage connected to the communication management service 160, 260 in association with the customer information of the calling party.

At block 307, the communication management service 160, 260 transmits customer information associated with the calling party such that the customer request management system 190, 290 can in turn provide the customer information to a device associated with the customer care agent. The customer information may be transmitted directly to the device of associated with the customer care agent or indirectly via the customer request management system 190, 290. In order to forward the received customer information, the customer request management system 190, 290 can identify, using the assigned request identification information, an established communication session and then locate the agent device 180 or the agent terminal 280 communicating via the identified established communication session. In that sense, the communication management service 160, 260 can transmit the assigned request identification information to the customer request management system 190, 290 in association with the customer information.

At block 308, the communication management service 160, 260 transmits an instruction for the customer request management system 190, 290 to provide the received customer information to a corresponding device associated with the customer care agent who responds to the requested call. The instructions may be sent to the customer request management system 190, 290 when the requested call is established. The instructions may include the request identification information of the requested call such that the customer request management system 190, 290 can locate the corresponding device of the (call-responding) customer care agent based on the request identification information.

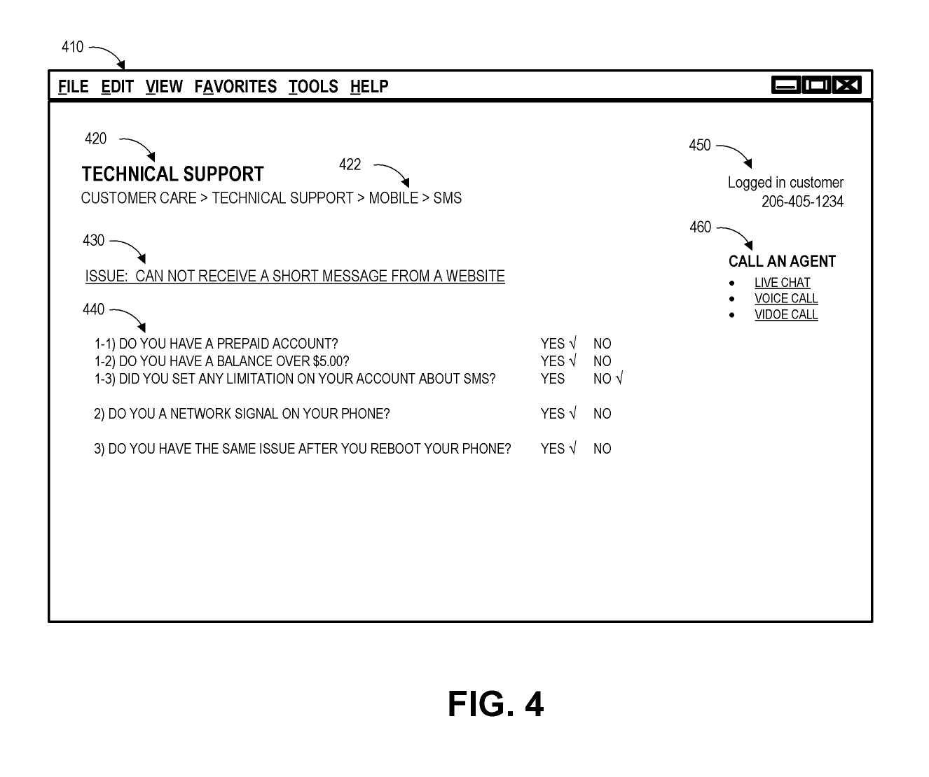

FIG. 4 illustrates an example of customer care page including a call link. This example customer care web page corresponds to a technical support page 410 of the customer care site 140, 2401, which can be accessed at a customer device 110, 210 via a web browser. As shown in FIG. 4, the technical support page 410 displays ‘TECHNICAL SUPPORT’ 420 as a higher category of the customer's issue and displays ‘MOBILE>SMS’ 422 as a detailed category of the customer's issue. The page 410 also shows an issue description 430 and questions 440 that have been answered by the customer. Account identification and/or contact information of the customer 450 can be displayed in the page 410 as the customer logged on the customer care site. The technical support page 410 further includes a set of links 460 that can be used to request a call, in the form of live chat, voice call, or video call. When the customer clicks one of the links 460, a request to make a call can be transmitted to the communication management service 160, 260 that will initiate processes to establish communication between the customer device 110, 210 and the agent device 180, 280 (and/or the agent phone 282). As explained above, the information displayed in the technical support page 410 can be transmitted to the customer request management system 190, 290. The customer care agent or representative who responds to the call initiated via the links 460 will be provided the transmitted information from the customer request management system 190, 290.

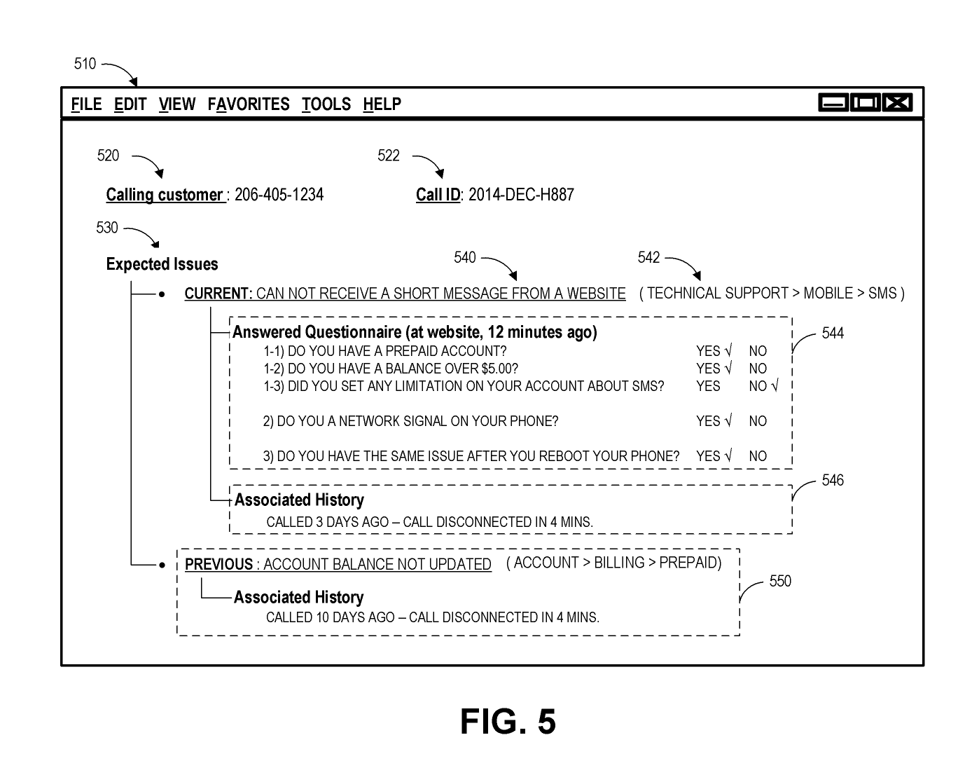

FIG. 5 illustrates an example of web page 510 including customer information as displayed on a customer care agent device. The web page 510 displayed at the agent device 180, 280 can display information 520 about a customer who requested a call via the customer care site 140, 240. The agent device 180, 280 is also operable to retrieve request identification information 522 associated with the call that the customer care agent is responding to from the customer request management system 190, 290 and displays the request identification information 522. The agent device 180, 280 further provides a portion of the customer information received from the customer care site server 230 in association with the request identification information 522 as the customer's expected issues 530. Detailed information regarding the customer's expected issues can include a title of the latest issue 540, a category of the latest issue 542, answered questions regarding the latest issue at the customer care site prior to requesting a call 544, and history associated with the latest issue 546. Detailed information regarding the expected issues further includes information regarding another previous issue 550 of the same customer. As the customer care agent is provided with customer information including previous issues 542, 550 of the customer, the customer care agent may not repeat all the same questions that have been already answered at the customer care site prior to requesting the call.

It will be appreciated by those skilled in the art that all of the functions described in this disclosure may be embodied in software executed by one or more physical processors of the disclosed components and mobile communication devices. The software may be persistently stored in any type of non-volatile storage.

Conditional language, such as, among others, “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without customer input or prompting, whether these features, elements and/or steps are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art. It will further be appreciated that the data and/or components described above may be stored assume in a computer-readable medium and loaded into memory of the computing device using a drive mechanism associated with a computer readable storage medium storing the computer executable components such as a CD ROM, DVD ROM, or network interface. Further, the component and/or data can be included in a single device or distributed in any manner. Accordingly, general purpose computing devices may be configured to implement the processes, algorithms, and methodology of the present disclosure with the processing and/or execution of the various data and/or components described above.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A computer-implemented method comprising:
as implemented by a computing system having a processor and a memory and configured with specific computer-executable instructions:
receiving a request from a client computing device to contact a customer care agent via selection of a first link on a first web page of a customer care web site, wherein the client computing device is associated with a customer of the customer care web site;
identifying destination information corresponding to the first link, wherein the destination information includes identification information associated with one or more customer care agent devices;
identifying customer activity information corresponding to one or more interactions by the customer with the customer care site via the client computing device prior to selection of the first link;
causing a communication session to be established between the client computing device and at least one customer care agent device based at least in part on the destination information; and
automatically generating a second web page based at least in part on the identified customer activity information, the second web page comprising an identification of the customer and at least a portion of the identified customer activity information; and
transmitting the second web page to the at least one customer care agent device for use in the communication session with the customer.

2. The computer-implemented method of claim 1, wherein the destination information is included in a resource identifier associated with the first link.

3. The computer-implemented method of claim 2, wherein the resource identifier comprises a uniform resource locator (URL).

4. The computer-implemented method of claim 1, wherein identifying the destination information comprises:
identifying the destination information based, at least in part, on the customer activity information.

5. The computer-implemented method of claim 1, wherein identifying the destination information comprises:
identifying the destination information based, at least in part, on a type of account associated with the customer.

6. The computer-implemented method of claim 1, wherein identifying the destination information comprises:
identifying the destination information based, at least in part, on a hierarchy associated with the first web page within the customer care web site.

7. The computer-implemented method of claim 1, wherein the customer activity information includes an identification of one or more web pages of the customer care site displayed to the customer prior to selection of the first link

8. The computer-implemented method of claim 1, wherein the customer activity information includes information regarding the customer's interaction with one or more web pages of the customer care site displayed to the customer prior to selection of the first link.

9. The computer-implemented method of claim 8, wherein the information regarding the customer's interactions includes customer responses to questions presented via the customer care web site.

10. The computer-implemented method of claim 8, wherein the information regarding the customer's interactions includes identification of a hierarchy of web pages of the customer care site traversed prior to selection of the first link.

11. The computer-implemented method of claim 1, wherein the second web page further comprises historical customer care information regarding one or more prior interactions of the customer with the one or more customer care agent devices.

12. A system comprising:
a computing device comprising a processor coupled to a memory, the memory including specific instructions that upon execution configure the computing device to at least:
receive a request from a client computing device to contact a customer care agent via selection of a first link on a first web page of a customer care web site, wherein the client computing device is associated with a customer of the customer care web site;
identify customer activity information corresponding to one or more interactions by the customer with the customer care site via the client computing device prior to selection of the first link;
cause a communication session to be established between the client computing device and at least one customer care agent device; and
automatically provide at least a portion of the customer activity information to the at least one customer care agent device for use in the communication session with the customer.

13. The system of claim 12, wherein the customer activity information includes an identification of one or more web pages of the customer care site displayed to the customer prior to selection of the first link

14. The system of claim 12, wherein the customer activity information includes information regarding the customer's interaction with one or more web pages of the customer care site displayed to the customer prior to selection of the first link.

15. The system of claim 14, wherein the information regarding the customer's interactions includes customer responses to questions presented via the customer care web site.

16. The system of claim 14, wherein the information regarding the customer's interactions includes identification of a hierarchy of web pages of the customer care site traversed prior to selection of the first link.

17. The system of claim 12, wherein automatically providing at least a portion of the customer activity information comprises:
automatically generating a message based at least in part on the identified customer activity information, the message comprising at least a portion of the identified customer activity information; and
transmit the message to the at least one customer care agent device for use in the communication session with the customer.

18. The system of claim 12, wherein automatically providing at least a portion of the customer activity information comprises:
automatically generating a second web page based at least in part on the identified customer activity information, the second web page comprising an identification of the customer and at least a portion of the identified customer activity information; and
transmit the second web page to the at least one customer care agent device for use in the communication session with the customer.

19. The system of claim 12, wherein automatically providing at least a portion of the customer activity information comprises:
in response to the request from the client computing device, transmitting a request to another computing device configured to manage historical customer care information regarding one or more prior interactions of the customer with the one or more customer care agent devices; and
causing the another computing device to provide at least a portion of the historical customer care information to the at least one customer care agent device for use in the communication session with the customer.

20. The system of claim 19, wherein the computing device is further configured to:
assign an identification to at least one of the request from the client computing device or the communication session;
associate the assigned identification with an identification of the at least one customer care agent device;
provide assigned identification to the another computing device, such that the another computing device can identify the at least one customer care agent device using the assigned identification.

21. A non-transitory computer storage medium storing computer-executable instructions that direct a computing device to perform operations comprising:
receiving a request from a client computing device to contact a customer care agent via selection of a first link on a first web page of a customer care web site, wherein the client computing device is associated with a customer of the customer care web site;
identifying customer activity information corresponding to one or more interactions by the customer with the customer care site via the client computing device prior to selection of the first link;
causing a communication session to be established between the client computing device and at least one customer care agent device; and
automatically providing at least a portion of the customer activity information to the at least one customer care agent device for use in the communication session with the customer.
